(19) United States
(12) Patent Application Publication
(10) Pub. No.: US 2005/0152140 A1
(43) Pub. Date: Jul. 14, 2005

(54) Decorative sheeting with illuminated sources

(76) Inventor: W. Richard Frederick, Hardy, VA (US)

Correspondence Address: JENKENS & GILCHRIST, P.C., 225 WEST WASHINGTON, SUITE 2600, CHICAGO, IL, 60606, US

(21) Appl. No.: 11/030,376

(22) Filed: Jan. 6, 2005

Related U.S. Application Data
(60) Provisional application No. 60/534,599, filed on Jan. 6, 2004.
(60) Provisional application No. 60/601,329, filed on Aug. 13, 2004.

(51) Int. Cl. F21S 6/00

(52) U.S. Cl. 362/235

(57) ABSTRACT

A decorative accumulation of snow around the base of a tree is simulated by attaching a string of spaced light sources to a decorative sheet of plastic material, placing the sheet of plastic material with the attached string of light sources around the base of a tree, and connecting a source of electrical power to the light sources to illuminate the light sources. The string of lights may be captured in a channel formed between two or more sheets of plastic film, with at least the uppermost sheet being white to simulate snow. The channel containing the light string may be sealed to protect the light string from ambient outdoor conditions.

### FIELD OF THE INVENTION

The present invention relates generally to seasonal, ornamental decorations, and more particularly to an illuminated tree skirt shaped to resemble a snow drift at the base of the tree.

### SUMMARY OF THE INVENTION

In accordance with the present invention, an illuminated ornamental tree skirt of flexible transparent or translucent plastic material is arranged around the base of a tree to resemble an accumulation of snow, such as a snow drift. Further, the illumination of the ornamental tree skirt creates a glistening effect on the top surface of the simulated snow. The ornamental tree skirt is suitable for seasonal exterior use, even in areas of little to no snowfall, to create or enhance a seasonal, winter scene.

The ornamental tree skirt is shaped to surround the trunk of a tree and is shaped to create whatever snow accumulation effect the user desires. Flaps are conveniently located on the skirt to cover any gaps, if desired, between the skirt and the tree trunk. The ornamental tree skirt is also equipped with stake holes or other anchoring attachments so that the skirt may be held against the ground.

The skirt may be illuminated with a convention string of ornamental lights, commonly used as Christmas tree decorations. The use of twinkle lights further enhances the glistening effect. The string of ornamental lights may be sandwiched between layers of the skirt material to protect against the weather, and the lamps may be oriented in a horizontal manner parallel with the layers of the skirt material to minimize breakage due to traffic.

The layers making up the ornamental skirt are preferably ventilated to reduce any internal buildup of moisture and/or mildew. There are also drain holes through all the layers of the ornamental skirt to provide a runoff path for any moisture that collects on the upper surface of the skirt. The internal string of lights is held in position away from the ventilation and drain holes to minimize the danger of any broken light glass escaping from the sandwiched material of the skirt.

The lower layer of the ornamental skirt is also preferably transparent or translucent so that the ornamental string of lights can be traced in the event that a lamp burns out. Thus, a burned out lamp, once located, can be removed through a small slit in the lower material, replaced, and the slit is then easily taped over to maintain the weather seal.

### BRIEF DESCRIPTION OF THE DRAWINGS

The invention may best be understood by reference to the following description taken in conjunction with the accompanying drawings, in which:

FIG. 1 is a diagrammatic illustration of an ornamental tree skirt wrapped around the base of a tree trunk, according to one embodiment of the present invention,

FIG. 2 is a top plan view of the tree skirt shown in FIG. 1, showing the main physical parts of the ornamental tree skirt,

FIG. 3 is the top plan view of FIG. 2 with the upper layers removed to show the placement of an internal string of ornamental lights,

FIG. 4 is a cross sectional view of the tree skirt of FIGS. 1-3, showing the layers of materials comprising the ornamental tree skirt and the orientation of the ornamental light string within, and

FIG. 5 is a diagrammatic illustration of a modified embodiment of an ornamental tree skirt wrapped around the base of a tree trunk.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

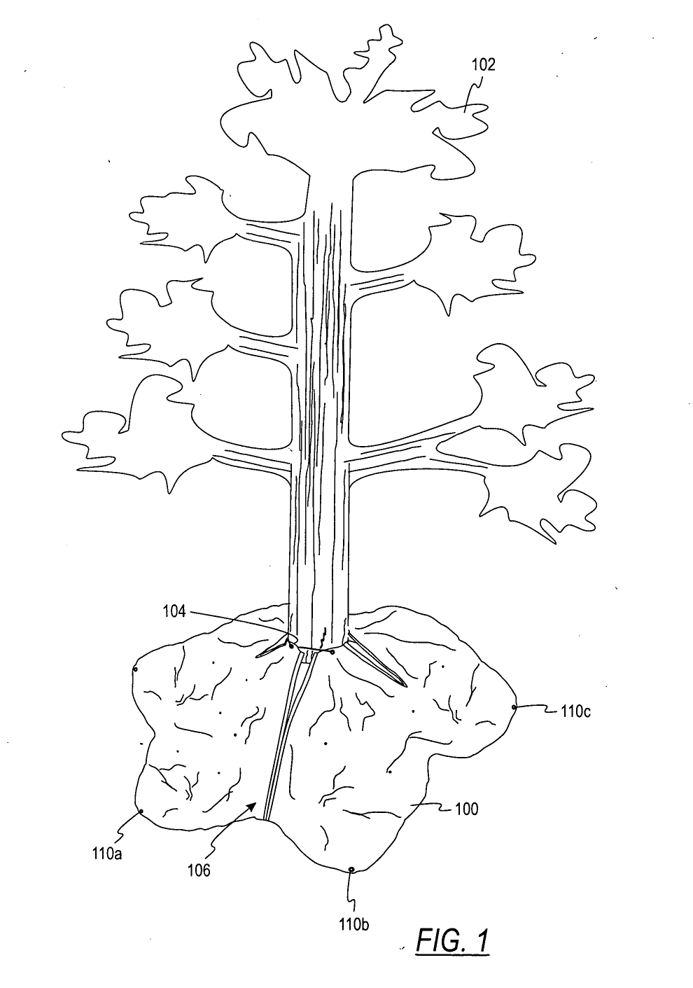

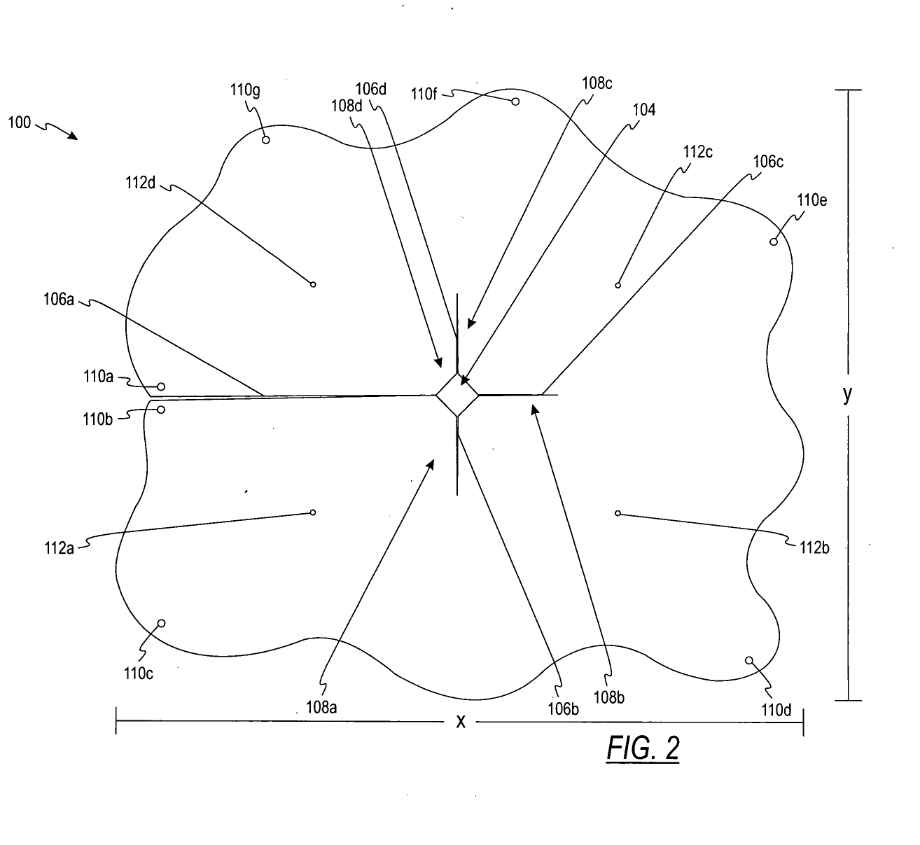

Turning now to the drawings and referring first to FIG. 1, an illuminated ornamental tree skirt 100 is designed to be placed around the base of an exterior tree 102 to simulate an accumulation of snow around the tree. A hole 104 in the center of the skirt 100, and slits 106a-106d (FIG. 2) extending outwardly from the hole 104, facilitate placement of the skirt around the tree. One of the slits, 106a, extends all the way through the outer periphery of the skirt. Seven stake holes 100a-110g, with a diameter of approximately ¼ inch, permit the tree skirt to be anchored to the ground with a plurality of stakes. A single stake (not shown) can be passed through the adjacent pair of stake holes 110a and 110b adjacent the slit 110a to keep the slit 106a closed, maintaining a continuous blanket effect at the base of the tree 102.

FIG. 2 is a top plan view of the ornamental skirt 100, which in one particular embodiment is approximately 55 inches in the x dimension and 50 inches in the y dimension. It can be seen that the outer peripheral edge of the skirt 100 has an irregular, undulating shape to provide the natural effect of a snow accumulation when the skirt is installed around a tree trunk. The central opening 104 provides enough space to accommodate the trunk of a tree 102 of approximately 7 inches in diameter. Four slits 106a-d extending outwardly from the opening 104 divide the skirt material around the opening 104 into four flaps 108a-d that may be folded over or arranged to accommodate a tree trunk with a diameter of approximately 30 inches. Four drainage holes 112a-d, with a diameter of 1/8 inch, provide drains for moisture that accumulates on the surface of the skirt 100.

According to another embodiment of the present invention, weights (not shown) may be incorporated into the ornamental skirt 100 to help keep it in place. This anchoring technique is especially valuable in areas where the ground conditions might prove an obstacle to using stakes to anchor the skirt 100, or where the added weight simply helps to maintain the skirt in place in varying environmental conditions.

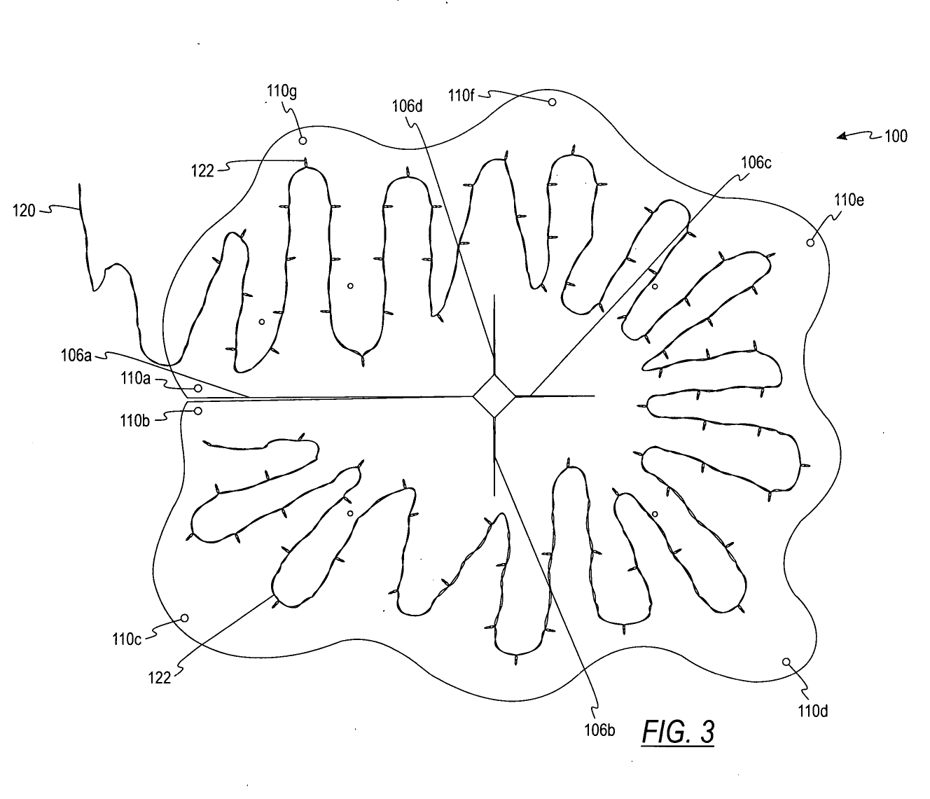

FIG. 3 shows a string 120 of decorative lights 122 distributed inside the skirt 100. In one embodiment, the enclosed string 120 has 100 decorative lights 122, although it will be understood that any desired number of lamps may be utilized, depending upon the desired effect and cost. The lights 122 may be of the flashing, twinkling or blinking variety, thus enhancing the glistening effect of a simulated snow bank at the base of a tree. The light string 120 is preferably located inside a two-ply skirt 100 with each of the lights 122 lying flat along the plane of the skirt 100 to minimize breakage.

As an alternative to a conventional light string, multiple light-emitting diodes (LEDs) may be employed.

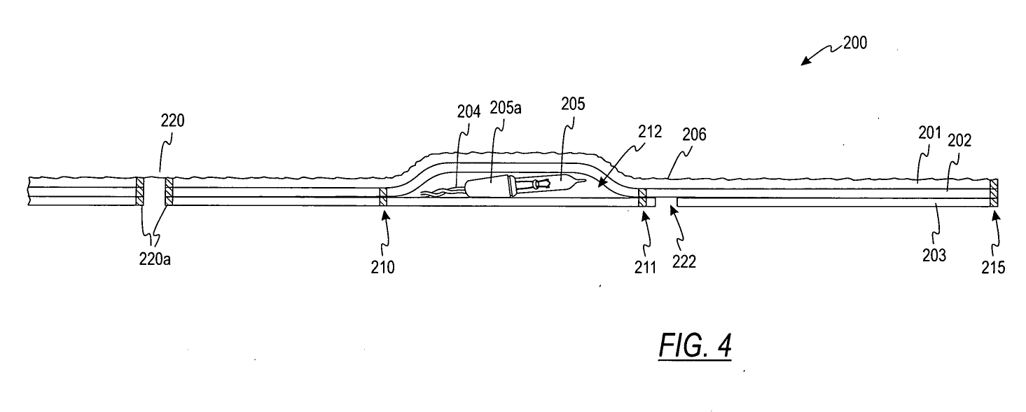

FIG. 4 is a sectional view of an ornamental tree skirt 200 having three layers 201-203 of translucent or transparent plastic film. A string 204 of ornamental lights 205 is encased between the two lower layers 202 and 203, and the uppermost layer 201 has a textured or roughened surface 206 to simulate the appearance of the surface of a snow drift. The translucency or transparency of the lowermost layer 203 enables a user to trace the encased string 204 for broken or failed lights 205. Once a bad light 205 is found, the lowermost layer 203 can be carefully slit, and the bad light 205 replaced. The repair slit opening can then be resealed with tape.

The layers 202 and 203 may be attached to each other as at 210 and 211 to form a channel 212 for the encased light string 204. The channel 212 maintains the position of the light string 204 within the tree skirt 200, providing the desired distribution of the lights 205 throughout the skirt 200 to provide the desired aesthetic effect. The plastic films may be attached by sewing, thermal bonding, adhesives, tape or any other desired technique to form the desired channel 212 for the light string 204. It will also be appreciated that the two layers 202 and 203 of plastic film need not be coextensive, as in the illustrative embodiment; for example, narrow strips of film may be laminated to a single large sheet only in those areas where reinforcement or channel formation is required, to reduce the overall amount of material required and thus reduce the material cost. Alternatively, tape or other attachment means may be used to attach the light string to the underside of a single-ply skirt, and to provide reinforcement around the openings in the skirt.

A soft plastic material of a white color and texture to resemble a layer of snow forms the visible, top layer 201 and is translucent so that light from the encased lights 205 is externally visible to provide a glistening effect when the lights are illuminated. According to one embodiment of the present invention, the upper surface of the top layer 201 has a puckered texture to simulate the surface of snow. A suitable thickness for the top layer 201 is about 4 mils, and the plastic material of all the layers is preferably resistant to mildew, stains and UV and remains flexible at low outdoor temperatures. The top layer 201 may be slightly larger than the underlying layers 202 and 203, but attached to the lower layers along the peripheral edges uniformly so that the top layer 201 has a slightly baggy appearance to aid in simulating the natural appearance of an accumulation of snow. The peripheral edges are preferably sealed or otherwise bonded through all the layers as at 215 to protect against the environment, or a separate U-shaped piece may be sewn or otherwise attached to the peripheral edges of the sheets.

Multiple drainage and stake holes 220 extend through all layers of the skirt 200, with sealing of the layers to each other around each hole, as at 220a, to provide environmental sealing. Eyelets or other types of reinforcement may be used around each of the holes 220 to provide edge reinforcement. Vent holes 222 are also preferably provided in the bottommost layer 203 of the skirt to prevent or reduce mildew. A suitable size for the vent holes 222 is 1/8 inch. The vent holes 222 are preferably distributed over substantially the entire area of the skirt 200, on an approximate 6-inch grid, but are not placed within the light-string channel 212 so as to minimize the chance of any hazardous glass particles from broken lights 205 sifting out of the skirt 200.

As can be seen in FIG. 4, the encased ornamental lights 205 are preferably maintained in a horizontal position within the channels 212 as an aid to prevent breakage from a person stepping on the skirt 200, or from the placement of an object on the skirt. The socket portions 205a of the lights 205 are somewhat thicker (e.g., 0.375 inch) than the bulb portions (e.g., 0.20 inch) and, therefore, help to prevent breakage of the bulbs when the lights are lying flat. The thickness of the multiple plastic layers 201-203 also helps prevent lamp breakage.

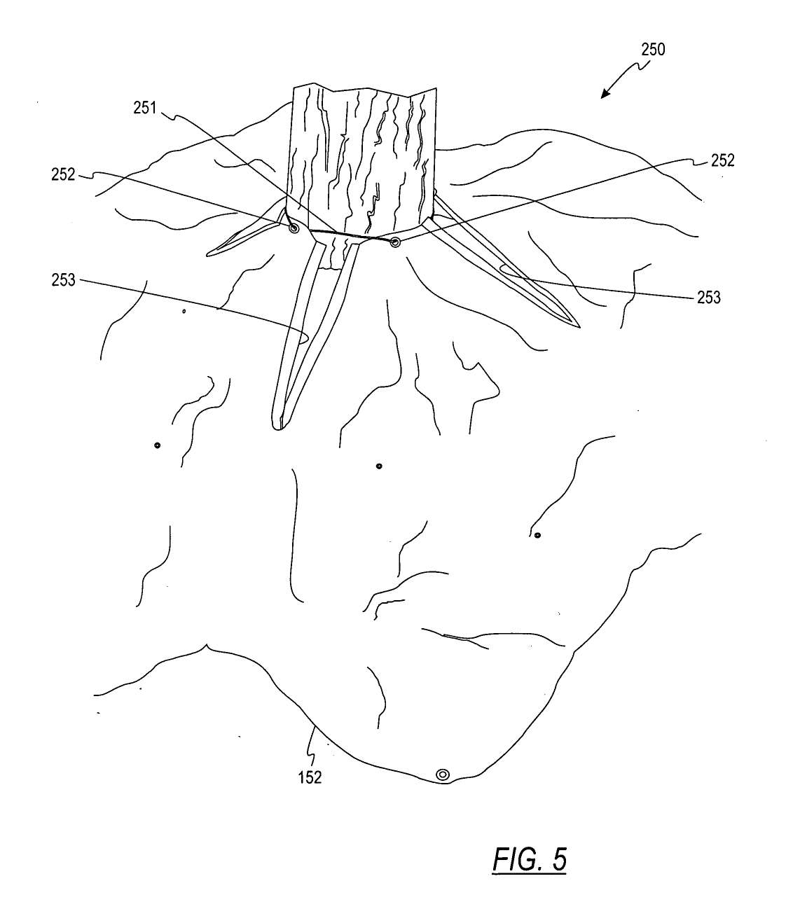

FIG. 5 illustrates a modified embodiment of a decorative tree skirt 250 in which a draw string 251 extends through multiple eyelets 252 formed at intervals around the inner periphery of the skirt 250. The draw string 251 is used to draw the inner edge of the skirt 250 snugly against a tree so as to hold that inner edge at the desired elevation, resisting any tendency of the skirt to slip downwardly along the tree trunk, even when loaded with snow or water. Maintaining the inner edge of the skirt 250 at the desired elevation enhances the ornamental effect of the illuminated skirt. It is preferred to provide at least one of the eyelets 252 between each pair of adjacent slits 253 extending outwardly from the inner edge of the skirt 250. Alternatively, other fastening devices may be used to draw the inner periphery of the skirt 250 tightly around the tree and to hold it in place.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A decorative tree skirt comprising:
multiple spaced light sources attached to a decorative sheet of transparent or translucent plastic material, and
an electrical connector attached to said string of light sources to connect a source of electrical power to said light sources.

2. The decorative tree skirt of claim 1 wherein said string of spaced light sources is a decorative light string having miniature lamps selected from the group consisting of steady-on, flashing, twinkling and blinking lamps.

3. The decorative tree skirt of claim 1 wherein said string of spaced light sources is disposed between said sheet of plastic material and a second sheet.

4. The decorative tree skirt of claim 1 wherein each of said light sources is a lamp mounted in a socket, and said lamps and sockets are disposed substantially parallel to said sheet of plastic material.

5. The decorative tree skirt of claim 1 wherein said skirt is shaped to resemble an accumulation of snow at the base of a tree.

6. The decorative tree skirt of claim 5 wherein the surface of said skirt is textured to simulate the surface of snow.

7. The decorative tree skirt of claim 1 wherein said plastic sheet includes at least one slit to facilitate the placement of said skirt around the trunk of a tree.

8. The decorative tree skirt of claim 1 wherein said plastic sheet includes drainage holes to prevent the build up of moisture on the upper surface of said plastic sheet.

9. The decorative tree skirt of claim 1 which includes at least one channel on the lower surface of said plastic sheet receiving said string of light sources to maintain said light sources in desired positions relative to said plastic sheet.

10. The decorative tree skirt of claim 1 wherein said skirt comprises a plurality of layers of plastic material attached to each other.

11. The decorative tree skirt of claim 10 wherein said layers include vent holes to prevent moisture and mildew buildup between and beneath said layers.

12. The decorative tree skirt of claim 1 which includes a plurality of fasteners to hold at least an edge of said skirt on the ground around a tree.

13. The decorative tree skirt of claim 1 which includes a fastener to hold at least an edge of said skirt on a portion of a tree trunk above the ground.

14. A method of simulating a decorative accumulation of snow around the base of a tree comprising:
attaching multiple spaced light sources to a decorative sheet of transparent or translucent plastic material,
placing said sheet of plastic material with said attached string of light sources around the base of a tree, and
connecting a source of electrical power to said light sources to illuminate said light sources.

15. The method of claim 14 wherein said string of spaced light sources is a decorative light string having miniature lamps selected from the group consisting or steady-on, flashing, twinkling and blinking lamps.

16. The method of claim 14 wherein said string of spaced light sources is disposed between said sheet of plastic material and a second sheet.

17. The method of claim 14 wherein each of said light sources is a lamp mounted in a socket, and said lamps and sockets are disposed substantially parallel to said sheet of plastic material.

18. The method of claim 14 wherein said skirt is shaped or textured to resemble an accumulation of snow when placed around the base of a tree.

19. The method of claim 14 wherein said plastic sheet includes drainage holes to prevent the build up of moisture on the upper surface of said plastic sheet.

20. The method of claim 14 which includes which includes at least one channel on the lower surface of said plastic sheet receiving said string of light sources to maintain said light sources in desired positions relative to said plastic sheet.

21. The method of claim 14 wherein said skirt comprises a plurality of layers of plastic material attached to each other.

22. The method of claim 14 which includes fastening at least an edge of said skirt on a portion of a tree trunk above the ground.

23. A decorative tree skirt for exterior use, comprising:
a string of spaced light sources attached to a decorative sheet of transparent or translucent plastic material, and
an electrical connector attached to said string of light sources to connect a source of electrical power to said light sources
